(19) United States
(12) Patent Application Publication
(10) Pub. No.: US 2012/0055555 A1
(43) Pub. Date: Mar. 8, 2012

(54) DIAPHRAGM VALVE

(75) Inventors: Denis Saint-Paul, Saint-Bonnet pres Riom (FR); Philippe Vernot, Riom (FR); Lilian Portier, Paslieres (FR)

(73) Assignee: BIO-RAD LABORATORIES, INC., Hercules, CA (US)

(21) Appl. No.: 13/038,766

(22) Filed: Mar. 2, 2011

Related U.S. Application Data
(60) Provisional application No. 61/310,613, filed on Mar. 4, 2010.

(51) Int. Cl. F16K 7/16; F16K 31/12; G05D 7/00; F16K 31/06; G05D 7/06

(52) U.S. Cl. 137/1; 251/331; 251/129.01; 251/319; 251/12

(57) ABSTRACT

Novel features enhancing the operation of a diaphragm valve include a specialized diaphragm profile for enhanced securement of the diaphragm in the valve body, and a quick-connect feature joining the diaphragm to its actuator, in which the forward end of the actuator contains a sloping surface, an expanded tip, and a shoulder, while the diaphragm contains a truncated bore with a complementary profile. The valve can be modular in construction to permit mounting of the valve to an instrument panel in close proximity to other valves or components to provide the ability to select among interconnected fluid flow paths.

### CROSS-REFERENCE TO RELATED APPLICATION

This application claims the benefit of U.S. Provisional Patent Application No. 61/310,613, filed Mar. 4, 2010, the contents of which are incorporated herein by reference.

### BACKGROUND OF THE INVENTION

1. Field of the Invention

This invention resides in the field of diaphragm valves for the control of fluid flow.

2. Description of the Prior Art

While diaphragm valves are widely used in fluid handling systems, certain features of diaphragm valves are of particular concern when the valves are used with fluids containing biological or pharmaceutical substances. One of these features is the ability of the valve to hold pressurized fluids without allowing leakage around or past the diaphragm when the valve is closed. Another is the ability of the user to remove the diaphragm from both the valve and the diaphragm actuator for purposes such as cleaning or replacement and then to quickly replace the diaphragm or reassemble the valve for further use. A third feature, which is applicable to diaphragm valves for all fluids, is to obtain a secure seal when the valve is closed without placing such a shear stress on the diaphragm that is great enough to cause damage of the diaphragm over time and repeated use.

### SUMMARY OF THE INVENTION

In one aspect, the present invention resides in a diaphragm valve with an actuator of a distinctive profile and a bore of complementary profile in the diaphragm, the two profiles allowing the user to fully secure the actuator to the diaphragm by simply pressing the tip of the actuator against the bore opening. The bore occupies only a small area at the center of the diaphragm and closure of the valve is achieved by contact of the portion of the diaphragm that is opposite the bore with the closure port in the valve body. Once the actuator and diaphragm are secured to each other, movement of the actuator compresses the diaphragm uniformly against the closure port, with no further contact required between the diaphragm and the valve body, other than securing the diaphragm in the valve body. Due to the distinctive profiles of the actuator tip and the bore, the actuator can be moved both toward and away from closure port without a risk of becoming disengaged from the diaphragm, despite the quick-connect character of the actuator tip and bore.

In another aspect, the present invention resides in a diaphragm having a profile that allows the diaphragm to be secured to the valve body. The diaphragm is designed with a section of expanded thickness at its outer rim and a complementary depression in the valve body or in the bonnet that is joined to the valve body to complete the valve housing, or both. When the bonnet is mounted to the valve body, the bonnet and valve body form a cavity at their contact surfaces to receive and grasp the raised section of the diaphragm, thereby fixing the diaphragm in place.

Certain embodiments of the present invention include both the actuator and bore feature and the diaphragm profile feature.

Further features, objects, and advantages of the invention will be apparent from the description that follows.

### BRIEF DESCRIPTION OF THE DRAWINGS

FIG. 1 is an exploded cross section of a portion of a diaphragm valve that embodies both aspects of the present invention.

FIGS. 2A and 2B are assembled cross sections of the diaphragm valve portion shown in FIG. 1, in closed and open positions, respectively.

FIG. 3 is a cross section of the diaphragm valve of the preceding figures mounted to an instrument panel.

### DETAILED DESCRIPTION OF THE INVENTION AND PREFERRED EMBODIMENTS

In those embodiments of the invention that feature the specialized actuator and diaphragm bore, the bore is a truncated bore, which means that the bore, while open to one side of the diaphragm, does not extend through the entire thickness of the diaphragm. The diaphragm is described herein as having a process side and an instrument side, the process side being the side in contact with the process fluid that either flows through the valve or is stopped by the valve from flowing. The instrument side of the diaphragm is the side opposite the process side and faces the features of the valve that control the position and movement of the diaphragm. These features include, for example, the pneumatic or other drive means for the actuator. The opening of the bore into which the actuator tip is inserted is thus on the instrument side of the diaphragm.

The valve body is the portion of the valve housing through which the fluid flows when the valve is open, and thus resides, at least in part, on the process side of the diaphragm when the parts are assembled. The valve body contains a closure port that is closed by the diaphragm when the actuator, and hence the valve as a whole, are in the closed position, and that is open to allow the process fluid to flow into and through the valve when the diaphragm is displaced from the closure port. The bonnet is the portion of the valve housing that is joined to the valve body such that these parts when joined enclose the diaphragm. The bonnet thus resides primarily on the instrument side of the diaphragm when the parts are assembled and contains components of the actuator drive mechanism. The bonnet and valve body are joined along contact surfaces in which the depression(s) are formed that grasp the diaphragm. The contact surfaces encircle the closure port when the bonnet and valve body are joined, and by “encircle” is meant “surround,” since while the bonnet and valve body are generally circular, they can alternatively assume other closed shapes, such as ovals or rectangles or other polygons, in which cases the closed shape is other than a circle. In preferred embodiments, the diaphragm itself acts as a seal between the bonnet and the valve body to help prevent the process fluid from leaking from the valve between the bonnet and valve body. In further preferred embodiments, the section of expanded thickness on the diaphragm extends along the entire rim of the diaphragm, thereby fully encircling the diaphragm. In the case of a circular diaphragm, the section can thus form a ring around the circumference of the diaphragm. The corresponding depression(s) in the contact surface(s) of the bonnet, valve body or both, will thus be a groove that extends the length of the contact surface.

In other embodiments of the invention, the actuator can be permanently affixed to the diaphragm, for example by the use of a permanent adhesive or by overmolding the diaphragm over the actuator.

In embodiments that feature a diaphragm with a section of expanded thickness on the diaphragm rim, the section of expanded thickness can be raised on one side of the diaphragm or on both sides. When the section is raised on one side, the complementary depression that receives the raised section will reside in the contact surface of the bonnet or valve body that faces the raised section. When the section is raised on both sides, the contact surfaces on both the bonnet and the valve body will have complementary depressions.

The profile of the actuator includes a shaft and an expanded tip that has a forward end and a rear end, the forward end being the end that enters the diaphragm bore first. The expanded tip is larger in diameter (or generally in lateral dimension, depending on the cross-sectional shape of the tip) than the mouth of the bore, and has a sloping surface that stretches the mouth to allow entry of the tip. The sloping surface can be cone-shaped, tapering to a point, a truncated cone (i.e., frustoconical), or rounded such as a rounded knob. The rear end of the tip forms a shoulder extending outward from the shaft. In preferred embodiments, the shoulder fully encircles the shaft and defines a plane perpendicular to the longitudinal axis of the shaft. The bore in the diaphragm has an inverse shoulder, which term is used herein to denote a shoulder facing in the direction opposite to that of the shoulder on the actuator shaft. The inverse shoulder is complementary in location and configuration to the shoulder on the actuator tip, and thereby preferably defines a plane perpendicular to the axis of the bore. The bore thus terminates in an expanded cavity bordered at the end closest to the instrument end of the diaphragm by the inverted shoulder. The expanded cavity is large enough to receive the expanded tip of the actuator, and in preferred embodiments, the tip and cavity form a close fit to prevent the tip from moving within the cavity. The actuator and diaphragm are thus joinable in a snap fit by virtue of the shoulder on the actuator tip and the inverse shoulder in the bore.

The diaphragm is flexible to allow the movement between the opening and closing positions, and sufficiently elastic to cause the mouth of the bore to return to its unexpanded position, or at least part way to its unexpanded position sufficiently to grasp the actuator shaft, once the actuator tip is fully inserted in the bore. Materials, notably elastomers, that are commonly used for the diaphragms in diaphragm valves can be used for the diaphragm of the present invention. Examples are EPDM (an elastomer made from ethylene-propylene diene monomer), FKM (fluoroelastomers), and FFKM (perfluoroelastomers).

While the diaphragm, actuator, and valve housing parts and components in accordance with this invention are all susceptible to a variety of configurations, the attached figures offer a depiction of one example to promote a further understanding of the invention as a whole.

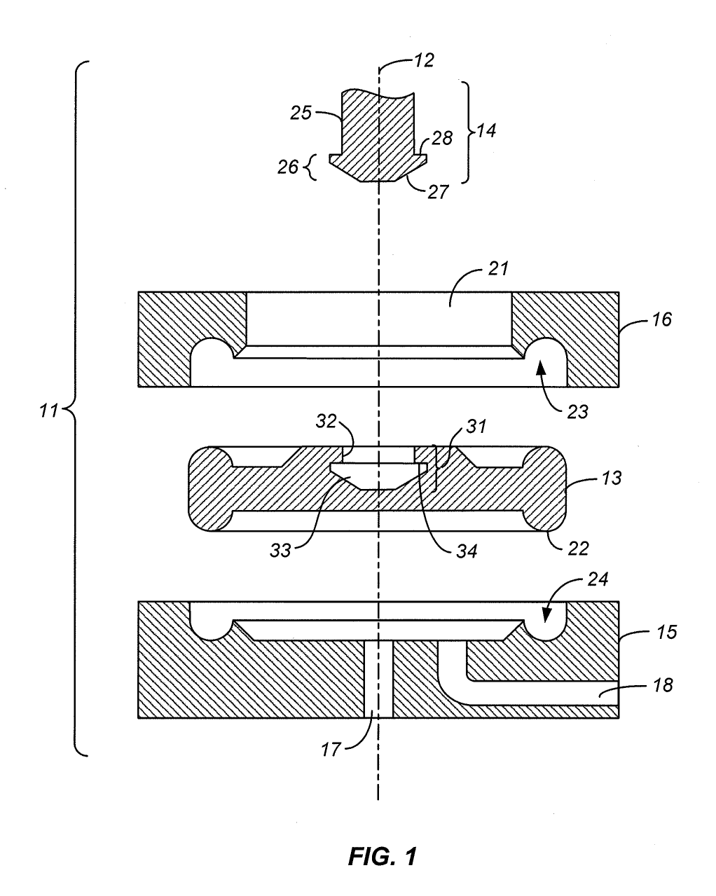

FIG. 1 is an exploded, cross-sectional view of a portion of diaphragm valve 11 taken along the longitudinal axis 12 of the valve, the axis also being the direction of movement of the actuator and the diaphragm. Each of the components shown is a body of revolution, or generally so, around the axis 12. The components shown are the diaphragm 13, the actuator 14, the valve body 15, and the bonnet 16. A closure port 17 in the valve body 15 serves as the inlet port for the fluid passing through the valve, and a second port 18 in the valve body serves as the outlet port. The bonnet 16 has a central opening 21 to allow passage and movement of the actuator 14. The aforementioned section of expanded thickness on the diaphragm is a peripheral ring 22, which is raised both above and below the adjacent areas of the diaphragm. In this particular diaphragm, the peripheral ring has rounded profiles on both top and bottom. Complementary depressions in the bonnet and valve body receive and grasp the ring to hold the diaphragm securely in place. The depression in the bonnet is thus a circular groove 23 of rounded profile encircling the opening 21 and opening downward (according to the view shown in the drawing). The depression in the valve body is also a circular groove 24 of rounded profile but one that opens upward.

The actuator 14 includes a shaft 25 and an expanded tip 26. The forward end of the tip has a sloping surface 27, which in this embodiment gives the tip a frustoconical shape, and the rear end forms a shoulder 28 where the tip meets the shaft. The bore 31 in the diaphragm is on the instrument side of the diaphragm and has a mouth 32 opening into an expanded cavity 33 that receives the expanded tip 27 of the actuator 145 in a close fit. The inverse shoulder 34 is complementary in size and position to the shoulder 28 on the actuator shaft.

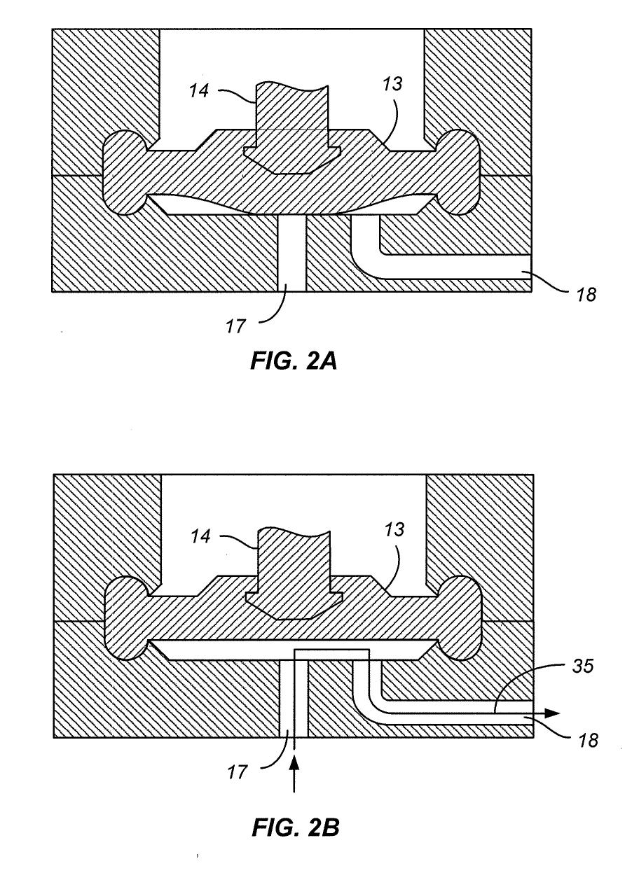

FIGS. 2A and 2B show the assembled diaphragm valve portions of FIG. 1 in closed and open positions, respectively, again in cross section. Securement of the diaphragm 13 to the actuator 14 has been achieved by simply pressing the actuator 14 against the mouth 32 of the bore 31, thereby stretching the mouth to accommodate the widest part (the shoulder 28) of the actuator tip. Once the entire tip has entered the cavity 33, the mouth snaps back into place over the actuator shaft. In the closed position of FIG. 2A, the diaphragm 13 has been moved downward by the actuator 14 to fully obstruct the closure port 17, while in the open position of FIG. 2B, the diaphragm 13 has been moved upward by the actuator 14 to clear the closure port 17 so that fluid can flow through the valve body in the direction indicated by the arrow 35. The complementary profiles of the actuator and the bore thus hold the actuator and bore securely together while force is applied in either direction. The length of travel of the actuator between the closed and open positions can be as little as a few millimeters. For example, the length of travel can be in the range of about 2 mm to about 20 mm, or preferably in the range of about 3 mm to about 10 mm. In addition, only a relatively small segment of the diaphragm, at its center, is needed to close the closure port 17, and this is accomplished with minimal distortion of the diaphragm. The diaphragm can be removed from the actuator by manually distorting the diaphragm to stretch the mouth sufficiently to permit withdrawal of the actuator tip.

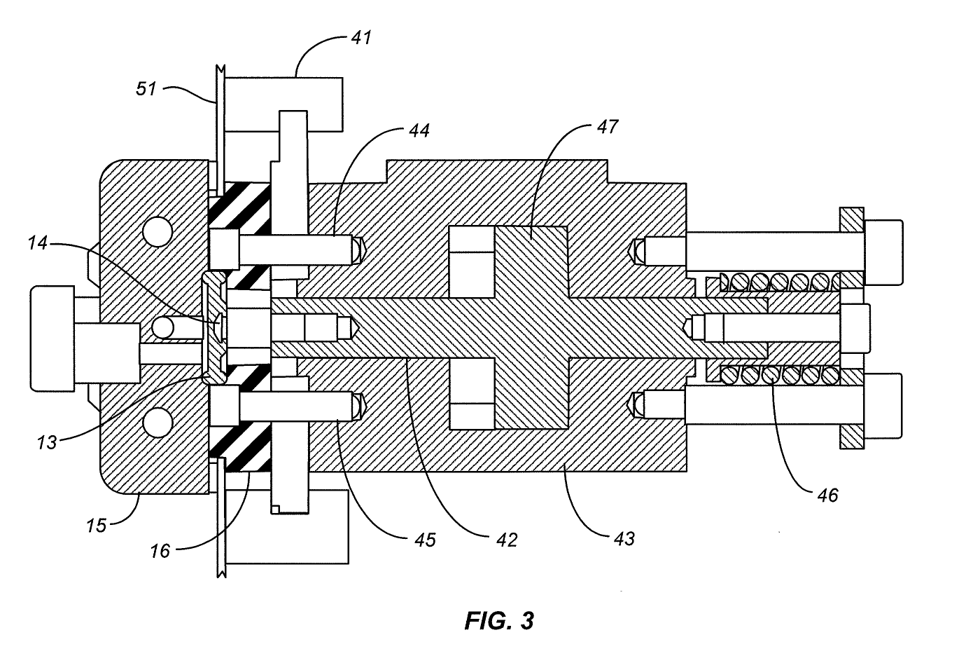

FIG. 3 is a cross section of a complete diaphragm valve containing the portions shown in the preceding figures, mounted to a manifold. The view is a cross section along the same longitudinal axis as the preceding figures but with the axis oriented horizontally. The diaphragm 13 is held between the valve body 15 and the bonnet 16 as in the preceding figures, and the bonnet 16 is mounted to a support frame or panel 41. The position of the actuator 14 is controlled by a pneumatically operated piston 42 to which the rear end of the actuator shaft is mounted. The cylinder 43 in which the piston 42 moves is mounted to the bonnet 16 through mounting screws 44, 45. The rear end of the piston 42 is encircled by a coil spring 46 that urges the piston 42 and hence the actuator 14 forward (to the left in the view shown in the drawing), to close the diaphragm against the closure port in the valve body. The application of air pressure within the interior of the cylinder 43 on the left side of the piston seal 47 urges the piston to the right and compresses the coil spring 46, displacing the diaphragm from the closure port and opening the valve. Thus, in this example, when the air pressure is released and the coil spring is in its relaxed position, the diaphragm valve is closed. Alternative configurations in which the valve is open while the coil spring is in its relaxed position can also be devised and will be readily apparent to those skilled in the art. Alternatives to the use of a pneumatic piston and cylinder are also well known in the art and can be substituted for the piston and cylinder shown in the drawing. Examples of such alternatives are electromagnetic driving mechanisms such as a solenoid valve, hydraulic mechanisms such as a water- or oil-driven piston, and mechanical mechanisms such as a manual lever or a screw. The structures and operations of each of these mechanisms are known in the art.

When the valve is mounted to an instrument panel as shown in FIG. 3, the fluid ports within the valve body are on the external side 51 of the panel, i.e., the left side in the view shown in the drawing. Two or more such valves can thus be mounted side by side in a modular configuration on the panel, offering choices of fluid flow paths between adjacent valves, particularly when each valve contains two or more ports in addition to the closure port. The valve bodies can be constructed in a compact and narrow profile, allowing adjacent valves to be placed close to each other. The panel mounting configuration shown in FIG. 3 further offers the advantage that the wetted parts of the valve, i.e., the valve body 15 and the diaphragm 13, can be removed from the remaining parts and from the panel for purposes of cleaning or replacement, without disturbing either the panel or the valve components on the interior side (i.e., the right side) of the panel.

Further features of preferred valves in accordance with this invention are that they contain minimal or no dead volume, i.e., enclosed volumes or interstices where fluids, and particularly biological or pharmaceutical liquids, can lie stagnant. Prevention of this type of stagnation helps prevent bacterial growth inside the valve, and thereby helps to keep the valve sanitary to protect both the user and subsequent fluids from contamination. The length of the fluid path through the valve is also minimized in preferred valves of the invention, thereby minimizing the volume of liquid held inside the valve, and the size of the manifold to which the valve is mounted.

The diaphragm valves and methods of this invention are useful in fluid systems in general, but particularly useful in the control of fluids containing bio-pharmaceutically active compounds within a system containing analytical instrumentation. Further alternatives to the structures, shapes, and arrangements shown in the figures that are still within the concept of the present invention include variations in the number and arrangement of the ports in the valve body, the shapes of the valve body and bonnet, the means of securing the parts together. Still further variations will be readily apparent to those of skill in the art.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is not excluded from the scope of the claim. All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. A diaphragm valve comprising:
(a) a flexible diaphragm having a peripheral rim and a section of expanded thickness on said rim; and
(b) a housing comprising:
(i) a valve body with a closure port therein,
(ii) a bonnet configured for securement to said valve body in a position encircling said closure port, such that said valve body and said bonnet when so secured meet at contact surfaces,
(iii) a depression in at least one of said contact surfaces to receive said section of expanded thickness of said peripheral rim of said diaphragm and to thereby fix said diaphragm in said housing over said closure port.

2. The diaphragm valve of claim 1 wherein said section of expanded thickness extends along the entire peripheral rim.

3. The diaphragm valve of claim 1 wherein both of said contact surfaces have depressions that jointly grasp said section of expanded thickness.

4. A diaphragm valve comprising:
(a) a flexible diaphragm having first and second sides and a peripheral rim, with a truncated bore in said first side, said truncated bore having a side wall with an inverted shoulder formed therein;
(b) a housing comprising:
(i) a valve body with a closure port therein, and
(ii) a bonnet configured for securement to said valve body in a position encircling said closure port, such that said valve body and said bonnet when so secured meet at contact surfaces and secure said diaphragm therebetween; and
(c) an actuator shaft movably mounted to said housing and terminating in an expanded tip sized for insertion in said bore, said expanded tip having a forward end and a rear end, said forward end having a sloping surface to cause elastic expansion of said bore when said tip is pressed against said bore and a shoulder on said rear end to engage said inverted shoulder of said bore when said tip is fully inserted, thereby fixing said actuator shaft to said diaphragm.

5. The diaphragm valve of claim 4 wherein said actuator shaft has a longitudinal axis, said shoulder on said rear end of said expanded tip of said actuator shaft fully encircles said actuator shaft, and said inverted shoulder in said side wall of said bore fully encircles said bore, said shoulder and said inverted shoulder each defining a plane perpendicular to said longitudinal axis.

6. The diaphragm valve of claim 4 wherein said valve body further comprises a second port on the same side of said diaphragm as said closure port.

7. The diaphragm valve of claim 4 further comprising means for moving said actuator shaft between a closed position wherein said closure port is stopped by said diaphragm and an open position wherein said diaphragm is displaced from said closure port to allow fluid flow through said closure port.

8. The diaphragm valve of claim 7 wherein said means for moving is a member selected from the group consisting of pneumatic means, electromagnetic means, hydraulic means, and mechanical means.

9. The diaphragm valve of claim 7 wherein said means for moving is a pneumatic cylinder.

10. The diaphragm valve of claim 7 wherein the distance traveled by said actuator shaft between said closed position and said open position is from about 2 millimeters to about 20 millimeters.

11. The diaphragm valve of claim 7 wherein the distance traveled by said actuator shaft between said closed position and said open position is from about 3 millimeters to about 10 millimeters.

12. The diaphragm valve of claim 4 wherein said diaphragm has a section of expanded thickness on said rim, and wherein said housing further comprises a depression in at least one of said contact surfaces to receive said section of expanded thickness of said diaphragm and to thereby fix said diaphragm in said housing over said closure port.

13. A method for controlling the flow of a liquid, said method comprising:
(a) passing said liquid through a diaphragm valve in said system, said diaphragm valve comprising:
(a) a flexible diaphragm having a peripheral rim and a section of expanded thickness on said rim; and
(b) a housing comprising:
(i) a valve body with a closure port therein,
(ii) a bonnet configured for securement to said valve body in a position encircling said closure port, such that said valve body and said bonnet when so secured meet at contact surfaces,
(iii) a depression in at least one of said contact surfaces to receive said section of expanded thickness of said peripheral rim of said diaphragm and to thereby fix said diaphragm in said housing over said closure port; and
(b) moving said diaphragm away from and towards said closure port and thereby to open and close said valve.

14. The method of claim 13 wherein said valve body further comprises a second port on the same side of said diaphragm as said closure port, such that said liquid flows from said closure port through said valve body to said second port when said valve is open.

15. The method of claim 13 wherein said section of expanded thickness extends along the entire rim.

16. The method of claim 13 wherein both of said contact surfaces have depressions that jointly grasp said section of expanded thickness.

17. The method of claim 13 wherein step (b) is performed by application of a member selected from the group consisting of pneumatic force, electromagnetic force, hydraulic force, and mechanical force.

18. The method of claim 13 wherein step (b) is performed by pneumatic action.

19. A method for controlling the flow of a liquid, said method comprising:
(a) passing said liquid through a diaphragm valve in said system, said diaphragm valve comprising:
(i) a flexible diaphragm having first and second sides and a peripheral rim, with a truncated bore in said first side, said truncated bore having a side wall with an inverted shoulder formed therein;
(ii) a housing comprising:
a valve body with a closure port therein, and
a bonnet secured to said valve body in a position encircling said closure port, with said valve body and said bonnet being joined at contact surfaces and securing said diaphragm therebetween; and
(iii) an actuator shaft movably mounted to said housing and terminating in an expanded tip sized for insertion in said bore, said expanded tip having a forward end and a rear end, said forward end having a sloping surface to cause elastic expansion of said bore when said tip is pressed against said bore and a shoulder on said rear end to engage said inverted shoulder of said bore when said tip is fully inserted, thereby fixing said actuator shaft to said diaphragm; and
(b) moving said actuator shaft relative to said housing to move said diaphragm away from and towards said closure port and thereby to open and close said valve.

20. The method of claim 19 wherein step (b) comprises moving said actuator shaft between a closed position wherein said closure port is stopped by said diaphragm and an open position wherein said diaphragm is displaced from said closure port, the distance between said closed position and said open position being from about 2 millimeters to about 20 millimeters in length.

21. The method of claim 19 wherein step (b) comprises moving said actuator shaft between a closed position wherein said closure port is stopped by said diaphragm and an open position wherein said diaphragm is displaced from said closure port, the distance between said closed position and said open position being from about 3 millimeters to about 10 millimeters in length.

22. The method of claim 19 wherein step (b) comprises moving said actuator along a longitudinal axis, and said shoulder on said rear end of said expanded tip of said actuator shaft fully encircles said actuator shaft, and said inverted shoulder in said side wall of said bore fully encircles said bore, said shoulder and said inverted shoulder both defining planes perpendicular to said longitudinal axis.

23. The method of claim 19 wherein step (b) is performed by application of a member selected from the group consisting of pneumatic force, electromagnetic force, hydraulic force, and mechanical force.

24. The method of claim 19 wherein step (b) is performed by pneumatic action.
